(19) United States
(12) Patent Application Publication
(10) Pub. No.: US 2016/0162601 A1
(43) Pub. Date: Jun. 9, 2016

(54) INTERFACE FOR CONTEXT BASED COMMUNICATION MANAGEMENT

(71) Applicant: AT&T Intellectual Property I, L.P., Atlanta, GA (US)

(72) Inventors: Randolph WOHLERT, Austin, TX (US); Mark STOCKERT, San Antonio, TX (US); Paul GAUSMAN, Bridgewater, NJ (US)

(21) Appl. No.: 14/559,676

(22) Filed: Dec. 3, 2014

(51) Int. Cl. G06F 17/30; G06F 3/0484

(52) U.S. Cl. CPC G06F 17/30958; G06F 17/3053; G06F 3/0484

(57) ABSTRACT

Methods, computer-readable media and apparatuses for presenting a first relationship graph are disclosed. A processor calculates a communication priority score for each of a number of contacts of a user. The communication priority score is based upon a communication priority score factor and a weighting. The processor determines a subset of the plurality of contacts having communication priority scores above a threshold, and generates the first relationship graph including an icon representing the user and a plurality of shapes overlapping the icon representing the user. Each shape is associated with one of a plurality of social groups of the user. Each shape includes a second icon representing a contact of the subset of the plurality of contacts that is a member of a social group that is associated with a shape. The processor presents a graphical input field for changing the weighting of the communication priority score factor.

The present disclosure relates generally to communication networks and, more particularly, to methods, computer-readable media and devices for generating relationship graphs for a user.

### BACKGROUND

Existing contact management methods are generally based on two-dimensional tables or listing models with data being depicted in rows and columns. Examples include contact lists and address books, where contacts are typically listed alphabetically. In some cases, a small number of recent contacts may be separately emphasized at the top of the list or in a separate list of recent contacts. Users may also have multiple identities that they use for communications, e.g., multiple email addresses, multiple telephone numbers, cell phone numbers, and application identities, such as user names for messaging services, voice over internet protocol (VoIP) applications, and so forth. Each of these identities may have its own mechanism for contact management, e.g., separate address books, separate contact lists, etc. However, these conventional contact management methods do not provide an effective or efficient user interface, especially when data for a large number of contacts needs to be considered.

### SUMMARY

In one example, the present disclosure discloses a method, computer-readable medium, and apparatus for presenting a first relationship graph. For example, the method may include a processor calculating a communication priority score for each of a plurality of contacts of a user. In one example, the communication priority score is based upon a communication priority score factor, where the communication priority score factor has a weighting. The method may further include the processor determining a subset of the plurality of contacts having communication priority scores above a threshold. In one example, the method further includes the processor generating the first relationship graph including an icon representing the user and a plurality of shapes overlapping the icon representing the user. In one example, each of the plurality of shapes is associated with one of a plurality of social groups of the user, wherein each of the plurality of shapes includes a second icon representing a contact of the subset of the plurality of contacts that is a member of a social group of the plurality of social groups that is associated with a shape of the plurality of shapes. The method may further include the processor presenting a graphical input field for changing the weighting of the communication priority score factor.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2 illustrates a first example of a relationship graph of a user, in accordance with the present disclosure;

FIG. 3 illustrates two views of a graphical interface depicting changes to a relationship graph of a user based upon changes to user-selectable weightings of communication priority score factors, in accordance with the present disclosure;

FIG. 4 illustrates two views of a graphical interface depicting alternative relationship graphs, in accordance with the present disclosure;

FIG. 5 illustrates a flowchart of a method for presenting a relationship graph, in accordance with the present disclosure; and

FIG. 6 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses methods, computer-readable media and devices for generating and presenting relationship graphs. Although the present disclosure is discussed below in the context of wireless access networks and an Internet Protocol (IP) network, the present disclosure is not so limited. Namely, the present disclosure can be applied to packet switched or circuit switched networks in general, e.g., Voice over Internet Protocol (VoIP) networks, Service over Internet Protocol (SoIP) networks, Asynchronous Transfer Mode (ATM) networks, Frame Relay networks, and the like.

In one example, the present disclosure provides an integrated context-based communication management service for creating and presenting relationship graphs for a user. For instance, the user's contacts (broadly encompassing friends, individuals with a relationship with the user, organizations or communities with a relationship with the user, and so on), may be derived from diverse data sources that are available to a network operator, such that the network is able to group the contacts of a user into different clusters representing different social groups of the user, e.g., a family cluster, a work cluster, a cluster for a particular sports or hobby group, a school cluster, a professional association cluster and so forth. In one example, the relationship graph comprises a human interface that is presented or displayed for a user and represents a user's contacts and social relationships with dynamically generated, graphical representations of intersecting social circles. For instance, each social circle includes at least one icon representing a contact. Each social circle also overlaps with an icon of the user in the center. Some of the social circles may also intersect with one another where at least one contact belongs to more than one of the user's social circles. This particular relationship graph is akin to a Venn diagram.

In one example, contact prioritization is determined by a formula with several factors (e.g., social relationship strength, communication history, location, social activity). Each of these factors provides a numerical value contributing to the “communication priority” score of a given contact. In one example, these factors are not equally weighted. For example, the user can control the weighting of each of these factors through usage of one or more “slider” interfaces, or other interface types. As the user manipulates the weighting of the factors, the resulting communication priority scores will change, and the contacts that are displayed in the relationship graph will change accordingly. Thus, the user can effectively change the prioritization of the recommended and represented contacts. The number of contacts that are displayed is also user-controllable. Accordingly, in one example, the contacts that are displayed in the relationship graph are based upon the contacts with the highest communication priority scores (broadly the term “highest” communication priority scores is determined as compared to a threshold communication priority score or in relation to other communication priority scores). As such, the use of any qualitative terms such as “highest,” “lowest,” “closest,” “furthest,” “more frequent,” and “less frequent” in the present disclosure broadly encompass the use of a threshold or determined in relation to other scores within a respective parameter. For instance, if the user sets the maximum number of contacts to be displayed at 10 (e.g., a threshold value), a subset of the 10 contacts with the highest communication priority scores are displayed.

In one example, the visual interface of the present disclosure can be manipulated between different “skins” or “views” for visualizing the data. A first view, comprising a relationship graph based on social circles, is mentioned above. A second view comprises a two-dimensional (2D) graph, with contacts represented as circles that are connected to the user as a central circle. The circle representing a contact may be color-coded according to a type of social relationship (e.g., if two contacts were in a same social circle in the Venn diagram view, they may have the same color in the 2D graph view). In one example, the distance of the lines is a function of the communication priority score of the contact, and the thickness of the line is a function of the relationship strength between the user and the contact. In the Venn diagram view, in one example the distance between the icon of the user in the center and the contacts in each social circle is dependent upon the relationship strength, and the size of the icon representing a contact is based upon the current “communication priority” score for that contact.

As contacts participate in events that change their status or context information, the graphs/data visualizations also automatically change, i.e., different contacts are prioritized based upon locations, activities, phone calls, text messaging, upcoming events in a calendar, and so forth. For instance, if there is an upcoming tee time for a golf event, in the Venn diagram view a contact who is a golf partner may be made larger to emphasize this contact as someone that the user likely should be communicating with at the current time. In the 2-D graph view, the circle for this contact could be moved closer to the user in the center to emphasize the current communication priority for this contact. These and other examples are described in greater detail below.

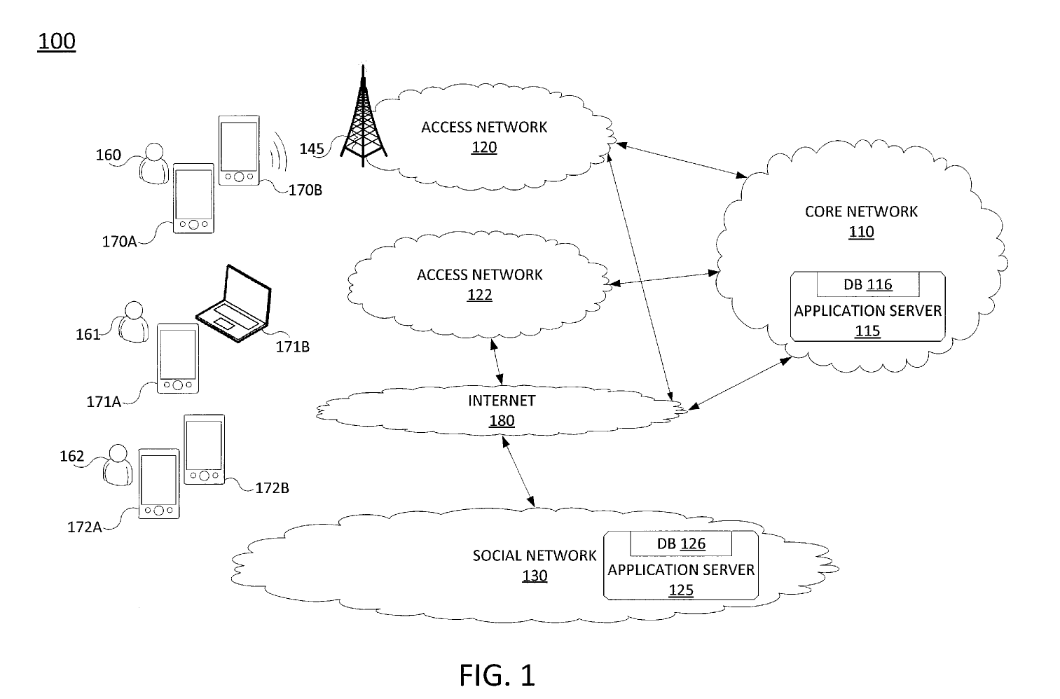

To aid in understanding the present disclosure, FIG. 1 illustrates a block diagram depicting one example of a communication network 100 suitable for performing or enabling the steps, functions, operations and/or features described herein. The overall communication network 100 may include any number of interconnected networks which may use the same or different communication technologies, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2 G, 3 G, and the like), a long term evolution (LTE) network, and so forth. It should be noted that an IP network is broadly defined as a network that uses Internet Protocol to exchange data packets.

As shown in FIG. 1, the system 100 connects endpoint devices 170A-172A and 170B-172B with each other and/or with one or more application servers via a core network 110, access networks 120 and 122, social network 130 and/or Internet 180. In one embodiment, core network 110, e.g., an IP network, interfaces with one or more of the access networks 120 and 122, and may also include interfaces to the Internet 180 and/or social network 130. Access network 120 may comprise a wireless access network (e.g., an IEEE 802.11/Wireless-Fidelity (Wi-Fi) network and the like) or a cellular access network, and may include a cellular base station and/or wireless access point 145. In one embodiment, access network 122 may comprise a PSTN access network, a cable access network, a wired access network and the like. In one embodiment, the access networks 120 and 122 and the core network 110 may be operated by different service providers, the same service provider or a combination thereof. Various interconnections between access networks 120 and 122, core network 110, Internet 180 and social network 130 are shown. In accordance with the present disclosure, it is contemplated that devices may utilize any one or a combination of such networks and interfaces in order to communicate with one another.

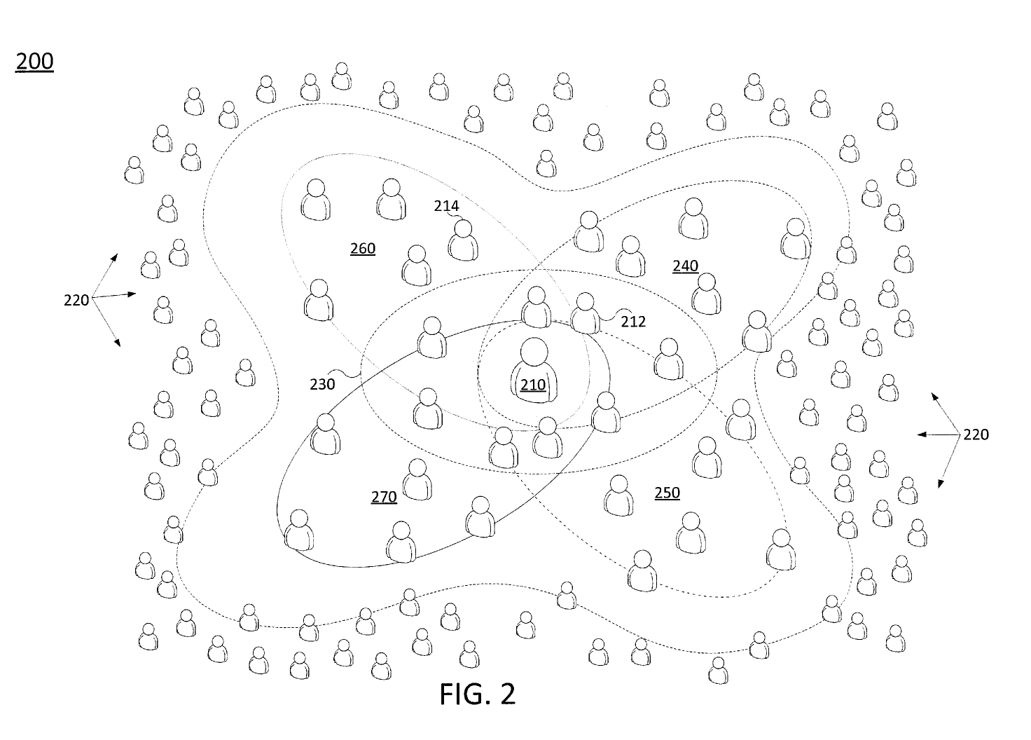

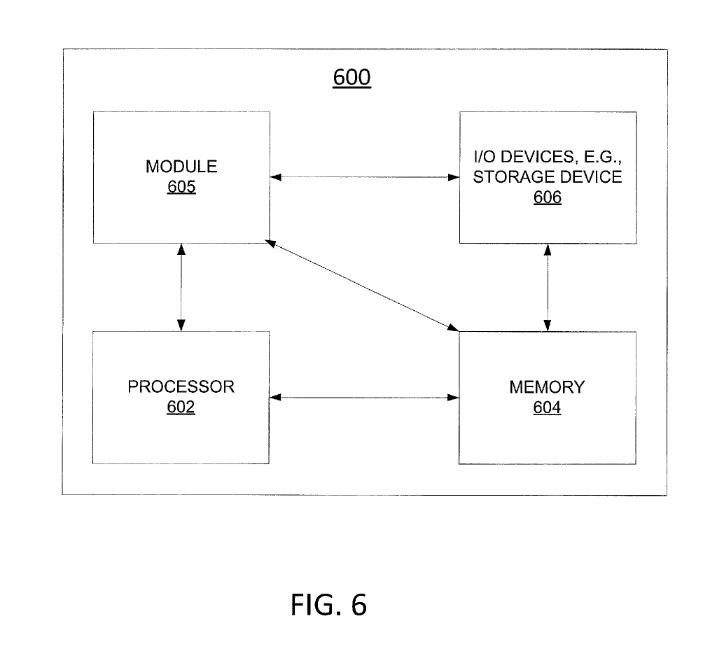

In one embodiment, the core network 110 may include an application server (AS) 115 and a database (DB) 116. Although only a single AS 115 and a single DB 116 are illustrated, it should be noted that any number of application servers 115 or databases 116 may be deployed. In one embodiment, the AS 115 may comprise a programmed computing device as illustrated in FIG. 6 and discussed below. In one embodiment, the AS 115 is configured to perform steps, functions and/or operations of a context based communication management service, e.g., for generating and presenting relationship graphs for users, accordance with the present disclosure. As such, DB 116 may store program code, data, files, and so forth to enable such functions. Thus, various embodiments are described herein as residing in or being performed in whole or in part by AS 115. For instance, AS 115 may calculate communication priority scores for various contacts of user 160 (e.g., users 161, 162, etc.) as the context information of such contacts change, e.g., locations, communication histories, volume of recent activity, and so forth. In one example, the calculation of such a score is in accordance with a formula having various factors, and with various weightings for such factors. In one example, the weightings are user-selectable. Thus, in one example, AS 115 may receive inputs from user 160 for selecting and changing such weightings, in accordance with the present disclosure. Examples of generating relationship graphs are described in greater detail below in connection with FIGS. 2-4.

Social network 130 may also include an application server (AS) 125 and a database (DB) 126, which may be the same or similar to AS 115 and DB 116 in the core network 110 and which are also suitable to perform at least the same functions. Similarly, in another embodiment a stand-alone application server (not shown), e.g., connected to Internet 180, may perform the same or similar functions.

In one embodiment, each of endpoint devices 170A-172A and 170B-172B may comprise an endpoint device configured for wireless or wired communication such as a personal computer, a laptop computer, a Personal Digital Assistant (PDA), a mobile phone, a smart phone, an email device, a computing tablet, a messaging device, a computing pair of glasses, and the like. As illustrated in FIG. 1, endpoint devices 170A-172A and 170B-172B may belong to and/or be associated with users 160-162. In particular, each of users 160-162 may have multiple associated endpoint devices. For example, user 160 may have both a personal smart phone (e.g., endpoint device 170A) as well as a work smart phone assigned by an employer (e.g., endpoint device 170B). Similarly, user 161 may have both a mobile phone (e.g., endpoint device 171A) as well as a personal computer (e.g., endpoint device 170B). In addition, user 162 may also have a personal smart phone (e.g., endpoint device 172A) as well as a work smart phone assigned by an employer (e.g., endpoint device 172B).

Notably, one or more of the users 160-162 may be a subscriber of access network 120 and/or core network 110. Accordingly, in one embodiment DB 116 of AS 115 in core network 110 may store profile information of one or more of users 160-162, e.g., users who are also network subscribers. Taking user 160 as an example, the profile information stored in DB 116 may include a name, billing address, service address, telephone number and email address associated with user 160. The profile information may also include geographic location information regarding user 160. For example, location information may be determined from a source IP address associated with communications from user 160, global positioning system (GPS) information of a mobile device of the user, serving base station information, and so forth. The profile information stored in DB 116 may also comprise biographic information, e.g., age, memberships in various groups, professional associations, and so forth, as well as calendar information for the user 160. The profile may also include a contact list of the user 160 that may comprise various contacts in various categories including: friends, family, colleagues, sports team members, hobby group members, and so forth.

In one example, user 160 defines various groups (e.g., social groups) and assigns different contacts to different groups. In one example, the contact list may include various different communication identities that can be used for different contacts. For example, the user may have only a telephone number for one contact. However, for another contact the user may store a number of communication identities such as: a home telephone number, a cellular telephone number, a work telephone number, an email address, an instant messaging username, a VoIP application username, and so forth.

To further illustrate, user 161 may be a work colleague of user 160. Thus, an entry in the contact list of user 160 for user 161 may include a work telephone number as well as a work email address of user 161. User 160 may also explicitly indicate that user 161 is a work contact, e.g., by entering “work” in a category field of the contact list entry. Similarly, user 162 may be user 160's sister. The contact list entry relating to user 162 may include a home telephone number, an email address and a work telephone number of the sister. In addition, user 160 may explicitly indicate a category of user 162 by entering “family” in a category field of the contact list entry.

Application server (AS) 115 may also access and/or store in DB 116 call detail records (CDRs) derived from telephone calls, emails, text messages, instant messages, multimedia messages (MMS), VoIP application usage, and the like which traverse various networks including core network 110, access networks 120 and 122, and so forth. Such CDRs may be gathered and accessed using any techniques which are well known in the art and may be used for various purposes in accordance with the present disclosure, as described in greater detail below. For instance, AS 115 may calculate communication priority scores for various contacts of user 160 (e.g., users 161, 162, etc.) as the context information of such contacts change, e.g., locations, communication histories, volume of recent activity, and so forth.

In addition, each of the users 160-162 may participate in social networking via social network 130. Thus, each of the users 160-162 may have a social network profile that includes: posts and messages of the user, biographic information of the user, information on contacts of the user and/or other participants of the social network with whom the user has interacted, location/check-in information of the user, and so forth. In one example, the social network profiles of each of the users 160-162 may be stored in database (DB) 126 of application server (AS) 125. Collectively, the information stored in DB 126 may be referred to as social network information and may be used for determining status or context information regarding various contacts of a user, for determining a best identity to use to communicate with a contact and for performing other functions in accordance with the present disclosure. For instance, application server (AS) 115 may access the social network information from AS 125/DB126 and use such information as an alternative to or in conjunction with contact information and call detail record information available to AS 115 to automatically determine the contacts of a user and to automatically assign the contacts to one or more of the groups.

It should be noted that the network 100 has been simplified. For example, the network 100 may include other network elements (not shown) such as border elements, routers, switches, policy servers, security devices, gateways, a content distribution network (CDN), firewalls, and the like. Thus, FIG. 1 is only intended to illustrate one exemplary environment in which embodiments of the present disclosure may be employed.

To further aid in understanding the present disclosure, FIG. 2 illustrates an exemplary relationship graph 200. For example, user 210 may subscribe to a context-based communication management service, which may be provided by core network 110, e.g., via AS 115, or by another network and/or network component illustrated in FIG. 1.

In one embodiment, the network may interact with various data sources regarding user 210 to construct relationship graph 200, including profile and contact list information, social network information and other context information such as phone calls, texts and the like. In one example, the network may rely upon explicit relationship indicators in order to create the relationship graph. For example, the network may rely upon the fact that user 210 is explicitly linked to contact 214 as a social network contact or upon the fact that user 210 has explicitly indicated that contact 212 is a relative in a contact list entry. In one embodiment, the user 210's contacts are also derived from diverse data sources that are available to a network operator, such as call detail records from traditional and cellular telephone usage, text messages, instant messages and email usage, social network usage, and so forth. Thus, through one or more of these available data sources, the network has insight into the relationships between and among many different users such that the network is ultimately able to group the contacts of a user into different communities or clusters, e.g., a family cluster, a work cluster, a cluster for a particular sports or hobby group, a school cluster, and so forth (broadly, “social groups” of the user).

For instance, an initial graph may be created for user 210 which places user 210 in the center and which shows four clusters: 240, 250, 260 and 270, where each cluster is represented as a respective oval. Although each cluster 240, 250, 260 and 270 is represented as an oval in relationship graph 200, in various other embodiments, the clusters of social circles may be represented by one or more different shapes, e.g., circles, hexagons, undefined closed-loop shapes, and so forth. Within relationship graph 200, contacts which are closer to user 210 are those who are deemed most relevant to the user (e.g., those with a highest relationship strength) and contacts which are further away are those which are deemed less relevant. In this example, there are a large number of contacts 220 which reside at the periphery of the relationship graph 200. These may represent many temporary contacts of the user. For example, the user 210 may keep an entry for his car mechanic in an address book/contact list, but may only call the mechanic on average once per year. In addition, the relationship between the user 210 and the mechanic may not involve any other common contacts. Thus, the mechanic does not fit well into any cluster and is not one of the most relevant contacts for the user.

On the other hand, cluster 240 may comprise family members of user 210. Each has a connection to user 210 and, since they are family members, also have connections to each other. Thus, these contacts of the user 210 form a cluster that is recognizable to the network. Similarly, cluster 250 may represent a hobby group that the user belongs to, e.g., a photography club. The user 210 may store contact information for various club members in his address book and may also have had actual communications including phone calls and text messages with different members. In addition, the other club members who are contacts of user 210 may also be contacts of one another such that the network recognizes these contacts as a cluster. Clusters 260 and 270 may be similarly formed and may represent respectively, a sports team to which user 210 belongs and work colleagues for a company.

In one embodiment, the network may be unaware of the actual significance of the clusters. Thus, the network may rely upon the user to label the different clusters 240-280 as a particular social group, e.g., “family,” “photography,” “soccer team,” and “work.” However, in another embodiment, the network may deduce the identities in different ways, e.g., correlating the same last names, explicit relationship indications in social network profiles and/or contact list entries, explicit indications by users that they are members of a particular group, etc.

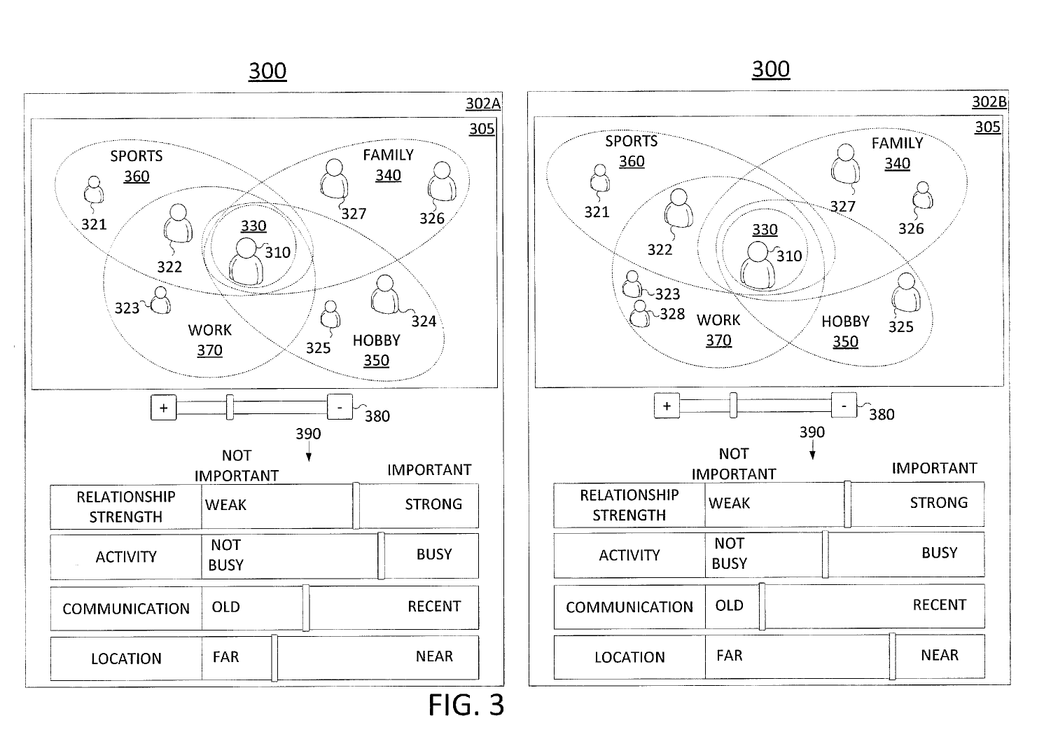

The relationship graph 200 also depicts a central region 230 which represents the most relevant contacts of user 210. In particular, since a user's number of contacts may be very great, a contact may be given a communication priority score based on a relationship strength, an activity rating of the contact (e.g., how active is the contact at the moment in communications), a communication history with the user, and a location (e.g., if the contact is nearby to the user, he/she may be given a higher priority score). The calculation of a communication priority score is described in greater detail below in connection with the example of FIG. 3. Then based upon a preference of the user and/or a screen size and resolution of a display, some, but not necessarily all of the contacts are displayed in a graphical interface based on the communication priority scores.

In one example, the size of the icon representing a contact is greater for contacts with a higher communication priority score as compared to contacts with lower communication priority score. Thus, in one example, the distance from the icon representing user 210 to a contact is based upon the relationship strength, whereas the size of the icon representing the contact, and the determination of whether or not the icon of the contact is displayed, is controlled by the communication priority score and a threshold representing the number of desired contacts to be displayed. In one example, the threshold is a user configurable parameter, e.g., where the user 210 can control the number of contacts displayed via a slider bar or other interface type. However, in one example, the threshold may take a default value, e.g., 10 contacts, 15 contacts, 20 contacts, etc., if the user 210 does not select a particular value for the threshold.

It should be noted that contacts of the user 210 are not necessarily limited to individuals, but can broadly include various entities or organizations. For instance, businesses, governmental entities, alumni associations, charities or similar non-profit entities, and the like may comprise contacts of user 210 and may be represented as icons in relationship graph 200. For example, if user 210 is a golfer and one of the clusters 240-280 represents a golf hobby group, user 210's frequent golf partners may appear as contacts, but golf courses, pro shops, sporting goods stores and the like may also be included as contacts in relationship graph 200. In one example, these businesses and organizations may be found as contacts insofar as these entities may have social media profiles to which user 210 is linked, and user 210 may have called telephone numbers registered to these entities, and so forth. These entities may also engage in activities which raise or lower communication priority scores, for instance, a golf course may make a series of social media postings advertising upcoming events at the golf course, which may affect an activity rating of the contact.

In one example, different social groups may be color coded to better distinguish the groups from one another. In one example, a default color coding scheme may be provided. However, in another example, user 210 may select particular colors for each social group. For example, user 210 may use an input device to click on or otherwise select the oval for social group 270. In response, a graphical interface may be presented to the user on the display to change the color for the oval. For instance, a pop-up menu, a drop down menu or the like may be provided with a selection of different colors.

In one example, user 210 can also categorize contacts into one or more different groups by dragging and dropping a contact's icon into an area that is overlapped by one or more of the shapes corresponding to various social groups. For instance, the icon for contact 212 may be moved into an area of overlap of the clusters 240 and 260. User 210 may take this action in response to contact 212 (e.g., who is a family member) joining a recreational soccer team of user 210. Thus, contact 212 is now a family member (social group 240) and a sports team member (social group 260).

To further aid in understanding the present disclosure, FIG. 3 illustrates two views, 302A and 302B, of a graphical interface 300 of the present disclosure, e.g., as presented on a display screen. Each of the views 302A and 302B depicts an exemplary relationship graph 305 but with different weightings of different communication priority score factors, as discussed below. As compared to relationship graph 200 of FIG. 2, the relationship graph 305 shows a more detailed view of the most relevant contacts of a user, e.g., user 310. For example, the relationship graph 305 may comprise the central region 230 in FIG. 2 in greater detail.

In the central cluster 330 of the relationship graph 305 is the user 310. Surrounding the user 310 are different clusters, or social groups, that include a family cluster 340, a hobby cluster 350, a sports cluster 360 and a work cluster 370. For illustrative purposes, only four clusters are illustrated in the relationship graph 305. However, it should be understood that a typical user may have many more clusters, or even fewer clusters, depending upon the number of various social groups to which the user belongs, the extent to which the user participates in communication network-based and social network-based services, and so forth. In addition, each cluster in the relationship graph 305 is represented as an oval.

In one example, user 310 may view the relationship graph 305 on the graphical interface 300 of a display screen and be able to click on different clusters and individual contacts to enter additional screens with even more refined details. For example, if user 310 clicks on contact 322, he may be taken to an additional screen or may receive a pop-up window with biographic information, contact details, calendar information, social network status information, a communication history, a location, and so forth regarding contact 322. In one example, recommendations provided by the context based communication management service are shown to the user 310 via the relationship graph 305. For instance, a dialog box may appear on or near an icon or picture representing a contact to signify that a communication is being recommended. In addition, the dialog box may include the indication, or reason for the recommendation. However, in another example, the network may send communication recommendations to user 310 via automated phone calls, text messages, emails and so forth.

In one example, the graphical interface 300 may be provided with a first graphical input field comprising a slide interface or icon 380 to zoom in or out. This slide interface or icon 380 allows the user to selectively enlarge or decrease the number of recommended contacts that are shown on the screen display. For example, if the user is very busy, the user may only want to see recommendations of the highest priority contacts that the user should contact, i.e., those with the highest communication priority scores. Alternatively, if the user is not very busy, the user may want to see more recommendations of contacts that the user should contact. In other words, the slide interface or icon 380 allows the user to customize a threshold number of recommended contacts to be displayed in the relationship graph 305. In the present example, in both views 302A and 302B, the threshold is set at seven (7) contacts. Although a slide interface 380 is shown in FIG. 3, it should be noted that in other, further and different examples, a different type of interface may be provided to enable a user to manipulate the number of displayed contacts. For instance, a dial interface, an interface with up/down buttons, a drop down menu interface with selectable values, and so forth may be utilized in various examples.

Additionally, in one embodiment selecting a contact from the main screen enables the user to view additional context information, and communication capabilities. The communication capabilities may actually allow the user to launch communication, e.g., an email link, a text message session and the like. Furthermore, if a user selects (e.g., clicks) on a group (e.g., social circle or cluster), then the user may “dive deeper” into the social circle, e.g., showing additional information for the group or each member of the group. For example, if the user clicks on a photography group from the main view, the method will provide a more detailed view of only the photography related contacts.

In one example, communication priority scores for the user's contacts are calculated in accordance with a formula having one or more communication priority score factors as follows:

PRᵢ=(RSᵢ×RSW)+(ARᵢ×ARW)+(CHᵢ×CHW)+(Lᵢ×LW) EQU 1

In Equation 1, ‘i’ represents the i^{th} contact of the plurality of contacts, PRᵢ is a communication priority score of the i^{th} contact, RSᵢ is a relationship strength between the user and the i^{th} contact, RSW is a weighting for the relationship strength, ARᵢ is an activity rating of the i^{th} contact, ARW is a weighting for the activity rating, CHᵢ is a communication history for communications between the user and the i^{th} contact, CHW is a weighting for the communication history factor, Lᵢ is a location factor, e.g., a distance between the user and the i^{th} contact, and LW is a weighting for the distance. The ellipsis at the end of Equation 1 indicates that the formula can be expanded to account for new/different factors and weightings for such factors. Notably, in one example Equation 1 may be supplied with default weights for each factor in order to calculate communication priority scores for each contact. As such, the present disclosure may determine which contacts will be displayed in the relationship graph 305 in accordance with the threshold number of contacts to be displayed, e.g., as selected via slide bar 380.

As illustrated in FIG. 3, the graphical interface 300 further includes one or more graphical input fields 390. For instance, each of the graphical input fields may correspond to one of the communication priority score factors of Equation 1. In the present example, there are four graphical input fields for the factors of: relationship strength (RS), activity (AR), communication (CH), and distance/location (L). In the present example, each of the four graphical input fields comprises a slide bar to control the importance or lack of importance of the corresponding factor. For instance, a slide bar positioned to the left of center (less importance) will provide a lower numerical weighting and a slide bar positioned to the right of center (greater importance) will provide a higher numerical weighting. Although graphical input fields 390 are shown as slide bars in FIG. 3, it should be noted that in other, further and different examples, a different type of interface may be provided to enable a user to manipulate the factor weightings. For instance, a dial interface, an interface with up/down buttons, a drop down menu interface with selectable values, and so forth may be utilized in various examples.

In one example, the relationship strength factor (RS) may be determined based upon customary notions of which relationships are the strongest, e.g., the value for the relationship strength factor (RS) for husband-wife, parent-child and sibling relationships may be numerically greater than those for other types of relationships. In declining importance, and hence a numerically declining relationship strength factor, next order of relationship may comprise second-tier relationships such as close friends, cousins and other extended family, and the most important work colleagues such as a boss or supervisor, team members, direct reports, etc. Next order of relationship may comprise less close friends, acquaintances, office colleagues that the user does not directly work with, sports team members, etc. For example, this order of relationship may comprise transactional contacts such as plumbers, electricians, mechanics, restaurants and other business that the user interacts with, and so on. Alternatively, or in addition, the user 310 may manually assign different relationship strengths to different contacts. Thus, different users will not necessarily be locked-in to a default scheme for assigning relationship strengths.

In one example, the activity rating factor (AR) comprises a volume of communication activity of a contact within a defined period of time, e.g., in the past week, past day, etc. In one example, the activity rating is a composite factor that time-weights communication activities, such that more recent communication activities will significantly contribute more to an activity rating than communication activities that have taken place further in the past. For example, each communication activity such as a telephone call, social media post, text message, email and the like may contribute a fixed value to the activity rating, where all of the values for all recent activities are summed to give the activity rating. However, the value for each contributing activity may be discounted by 10 percent for each day that has passed since the activity. Thus, after 10 days, the particular activity will no longer contribute to the contact's activity rating. In one example, activities occurring on the current day may be positively weighted, e.g., counting 50 percent more or two times more than activities on the immediately preceding day. The foregoing is just one illustrative example of the calculation of an activity rating. Thus, those skilled in the art will appreciate that various alternative weighting algorithms may be implemented in order to calculate an activity rating in accordance with the present disclosure.

In one example, the communication history factor (CH) relates to the “freshness” of a last communication between the user 310 and a contact. For instance, a greater duration of time that has elapsed from a most recent communication between the user 310 and the contact results in a lower communication priority score as compared to a lesser duration of time that has elapsed from the most recent communication between the user 310 and the contact. Lastly, the location factor (L) may be determined by calculating a distance between a current location or last known location of user 310 and a current or last known location of the contact.

As mentioned above, Equation 1 for calculating the communication priority score may be modified to include various additional factors. For example, an additional factor may relate to an upcoming scheduled event associated with one or more contacts, e.g., an “approaching event” factor. To illustrate, user 310 may have made plans to visit contact 321 on a Friday. As the week progresses and as Friday approaches, the priority of contact 321 may increase as the scheduled time draws closer. For instance, this factor may be inversely related to the duration of time to the event. Like all other factors, an option may be provided to user 310 to adjust a weighting of the “approaching event” factor.

In another example, the graphical interface 300 may further provide a graphical input field or other mechanism to allow user 310 to manually prioritize a contact. In one example, the manual prioritization may have an associated factor and weighting that is added to Equation 1. In another example, the manual prioritization may simply override any communication priority score calculations and guarantee that the selected contact will be displayed in the relationship graph 305.

In still another example, an option may be provided to user 310 to manually prioritize an entire social group. For instance, user 310 may click on or otherwise select one of the shapes corresponding to clusters 340, 350, 360 or 370 and a menu option may appear to alter the priority of the cluster/social group. In one example, the menu option, when selected, may cause an additional graphical input field, e.g., another slide bar, to be presented to enable the modification of a priority of the group that is selected. Notably, a factor for “group importance” and a corresponding weighting factor may be provided as an additional field in Equation 1. In one example, each possible social group may be associated with a respective additional factor to be added to Equation 1. Thus, a contact who is a member of multiple social groups may have his or her communication priority score impacted by the user 310 manually prioritizing or de-prioritizing any one or more of such social groups by altering the respective weightings. Thus, the user 310 may wish to prioritize work contacts when a work deadline is approaching, prioritize golf friends when a golf tee time is approaching, and so forth. Alternatively, or in addition, prioritization of different social groups could be automated. For instance, based on calendar entries of user 310 and/or one or more of the contacts 321-328, the present disclosure may determine that an event such as an upcoming work deadline, a sporting event, a graduation, etc., is approaching, correlate the event to one or more social groups that are impacted by the event, and automatically adjust the weighting for the impacted social groups to increase the contribution of the associated factors to the contacts' communication priority scores.

View 302A illustrates the relationship graph 305 when a first set of weightings is applied for the various factors, while view 302B illustrates the relationship graph 305 with a second set of weightings applied for the factors. For instance, if relationship strength is important to the user 310, the slide bar for relationship strength can be positioned to more heavily favor contacts having strong relationships with the user over contacts having weak relationships with the user. This preference is shown in view 302A where the slide bar for relationship strength is positioned to the right of center. If the contact being currently active is important to user 310, the slide bar for the activity can be positioned to favor busy contacts as compared to non-busy contacts (e.g., as also shown in view 302A, the slide bar is positioned to the right of center for the “activity” factor). Similarly, in view 302A, the slide bar for communication is positioned in the center, indicating that user 310 has no particularly strong preference with respect to whether or not he has recently communicated with a contact, but does not want to discount the importance of this factor entirely. Finally, as also shown in view 302A the slide bar for location/distance is positioned to the right of center, which may indicate that the user 310 would specifically like to deemphasize the factor of location/distance. In other words, far away contacts will not be penalized, or will only be penalized in a nominal way as compared to contacts that are nearer to the user 310, in calculating communication priority scores for each contact.

In view 302A, in accordance with the weightings selected through the graphical input fields 390, the seven contacts (contacts 321-327) with the highest communication priority scores are displayed in the relationship graph 305. In one example, distances between the icon for user 310 and icons for contacts 321-327 are based upon a relationship strength between the user 310 and each particular contact. For instance, on the display screen, contact 322 is closer to user 310 than contact 321, which may indicate that contact 322 has a stronger relationship with user 310. For example, contact 322 may be the work supervisor of user 310 and may also be a member of the same recreational soccer team, whereas contact 321 is only a team member, but is not a member of any other social group of user 310 and does not have frequent communications with user 310. In addition, in one example the sizes of the contacts' icons are based upon the communication priority score for each contact.

For instance, the icon for contact 324 is larger than for contact 325. Contact 325 may be a friend of user 310 who is making a rare visit from another city and will be in town for a short while. However, in view 302A, the slide bar for distance/location has been set to deemphasize this factor. Thus, the fact that contact 325 is nearby does not significantly increase the communication priority score of contact 325. On the other hand, contact 324 may be posting many new pictures on her blog throughout the day. Since the activity rating factor has been heavily weighted in view 302A, the communication priority score for contact 324 will be greatly increased insofar as contact 324 has had much recent activity. Note that contact 324 and contact 325 are approximately the same distance from user 310, which may indicate that these contacts have similar relationship strengths with user 310. However, in another example, different aspects of the relationship graph 305 may be impacted by different factors in an alternative manner. For instance, the distance between a contact's icon and the user 310 in the center may be based upon the communication priority score of the contact, while the size of the icon may instead be based upon the relationship strength.

View 302B illustrates the relationship graph 305 using a set of alternative weightings, e.g., where the communication history factor is specifically deemphasized and the location factor is specifically emphasized. As compared to view 302A, in view 302B the relationship graph 305 shows a different set of contacts (321, 322, 323, 325, 326, 327, and 328). Contact 328 is added and while contact 324 has been dropped based upon changes in communication priority scores, and due to the different weightings of the various factors. In view 302B, the location/distance factor has been weighted more heavily, while the communication history factor has been strongly deemphasized and the activity rating factor has been moved to a more neutral weighting. Thus, for instance, if the user 310 is currently located at his work office, and has strongly weighted the distance/location factor, contacts who are coworkers of the user may have greater communication priority scores. As such, the communication priority score for contact 328 (e.g., a coworker) has moved into the top seven scores, while the communication priority score for contact 324 has fallen from the top seven. Therefore, while contact 324 may have posted many new pictures on her blog, the weighting for the activity rating factor has been lowered, causing a decline in the communication priority score for contact 324. On the other hand, contact 328 is added and contact 324 is dropped from the current relationship graph 305.

In addition, the distances between the icons for various contacts and the icon for user 310 in the center may change due to differences in the communication priority scores. For instance, contact 325, who may be in town visiting from another city, will see an increase in his communication priority score moving from view 302A to view 302B (the location/distance factor has been more heavily weighted in view 302B). As such, the distance between contact 325 and user 310 in the relationship graph 305 may become shorter, or the size of the icon for contact 325 may increase in size as compared to the icon in view 302A, depending upon the particular embodiment.

When updated context information is received for a contact, or the user 310, the communication priority score for the contact may be recalculated in accordance with the current weightings in effect. For example, a new communication between the user 310 and one of the contacts may be detected. This updated context information will trigger a recalculation of the communication priority score for the contact (and in this case will result in an increase in the communication priority score via the communication history factor (CH)). In another example, the updated status information may comprise a change in location of the contact, a change in location of the user 310, or simply a change in the distance between the user 310 and the contact. When the communication priority score is recalculated, this will impact the location/distance factor (L). In yet another example, the updated status information may comprise a new activity of the contact, e.g., phone/voice or text communications with others, social network activity such as posts, likes, etc., calendar activity, such as reserving a time for an upcoming event, and so on. Updated status information may further comprise a change in time to an upcoming calendared event, such as a sporting event, a social commitment, a recurring milestone for the contact, etc. Updated status information may be gleaned from any of the same types of records used to determine initial communication priority scores for the various contacts, e.g., call detail records of one or more communication networks, social network activity records, calendar entries to which the user and/or the contact have granted access, and so forth.

It should be noted that various alternative arrangements may be provided for the graphical interface 300 in accordance with one or more alternative embodiments. For instance, instead of the graphical interfaces 380 and 390 being presented horizontally, one or more of the slide bars of the graphical interfaces 380 and/or 390 may be stacked vertically, e.g., along a left or right side of the graphical interface 300 in the same orientation as shown in FIG. 3. Alternatively, or in addition, one or more of the graphical interfaces 380 and 390 may be provided in a vertical orientation via a drop-down menu, e.g., from a horizontal toolbar. Notably, this allows new slide bars to be added to the graphical interface 300 to accommodate new, alternative and additional factors added to Equation 1, without requiring the use of additional screen space.

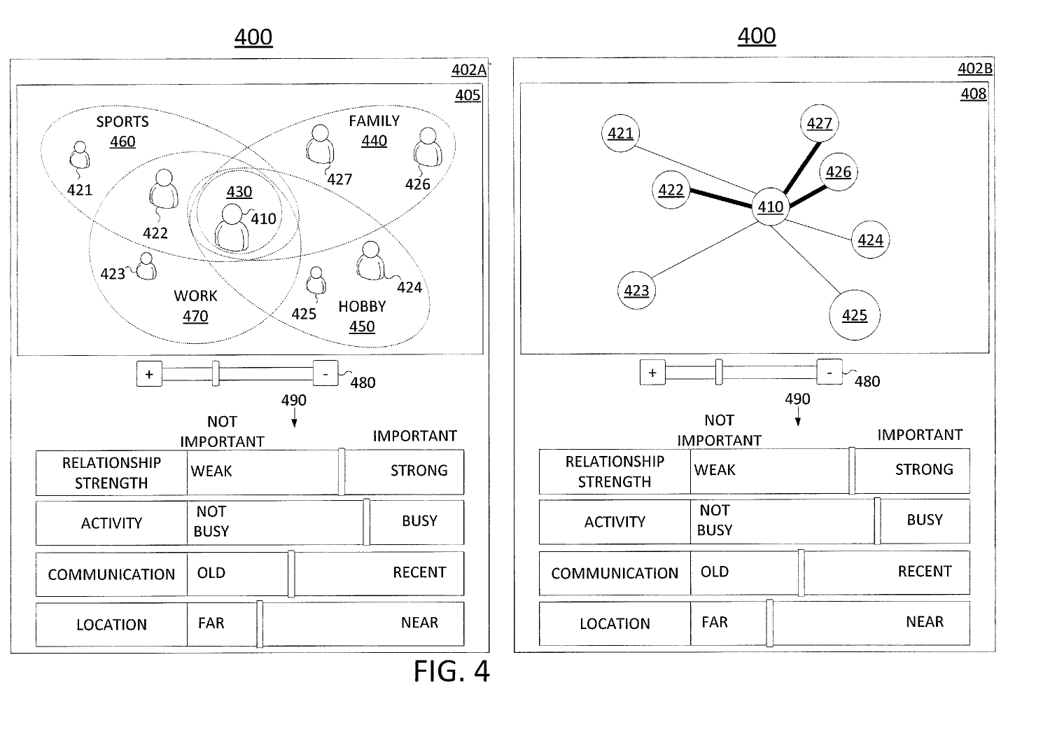

FIG. 4 illustrates two views, 402A and 402B, of a graphical interface 400 of the present disclosure, e.g., as presented on a display screen. View 402A depicts a first type of relationship graph 405, e.g., a Venn diagram view, whereas view 402B depicts a second type of relationship graph 408, e.g., 2D graph view. View 402A may comprise the same or substantially similar view to that of view 302A in FIG. 3. Thus, components of view 302A may correspond to similar components in view 402A, e.g., relationship graph 305, user 310, contacts 321-327, the shapes representing social groups 340, 350, 360 and 370, and graphical input fields 380 and 390 may correspond to relationship graph 405, user 410, contacts 421-427, the shapes representing social groups 440, 450, 460 and 470, and graphical input fields 480 and 490, respectively.

In contrast, in the 2D graph view (view 402B), relationship graph 408 represents user 410 as a circle in the center of the graph. Contacts are represented as circles dispersed around the center and are connected to the circle for user 410 via respective connector lines. Thus, circles 421-427 correspond to the same contacts 421-427 depicted in relationship graph 405 of view 402A. In one example, the distances of the connector lines are a function of the communication priority rating of the respective contact, while the thickness of the line is based upon the relationship strength between the contact and user 410. For instance, thick lines connect user 410 to contacts 422, 426 and 427, which may comprise user 410's boss, sister and brother, respectively. On the other hand, thin lines connect user 410 to contacts 421, 423, 424 and 425. For instance, contact 421 may comprise a teammate of user 410 on a recreational soccer team, but user 410 does not often communicate directly with contact 421. As another example, contact 423 may be a coworker of user 410, but user 410 does not work on many projects with contact 423.

It should be noted that in an alternative configuration, relationship graph 408 may instead use a distance between contacts and the user 410 to indicate a relationship strength, whereas line thickness is used to indicate a communication priority score. In addition, in other, further and different examples, alternative methods may be used to indicate relative communication priority scores, e.g., a blinking icon or circle, where a shorter interval of the blinking corresponds to a higher communication priority score, and so forth. Similarly, relationship graph 408 may utilize one or more different shapes such as triangles, squares, hexagons and the like as an alternative to, or in addition to the circles as shown in view 402B. For instance, social group 440 may be represented with circles for each contact, while social group 450 may be represented by squares. In still another example, social groups of the user 410 may be color coded. However, some contacts may fall into multiple groups. As such, for these contacts, the shape representing the contact and/or the connector line may comprise alternating colors corresponding to each social group to which the contact belongs. These and other variations are all contemplated within the scope of the present disclosure.

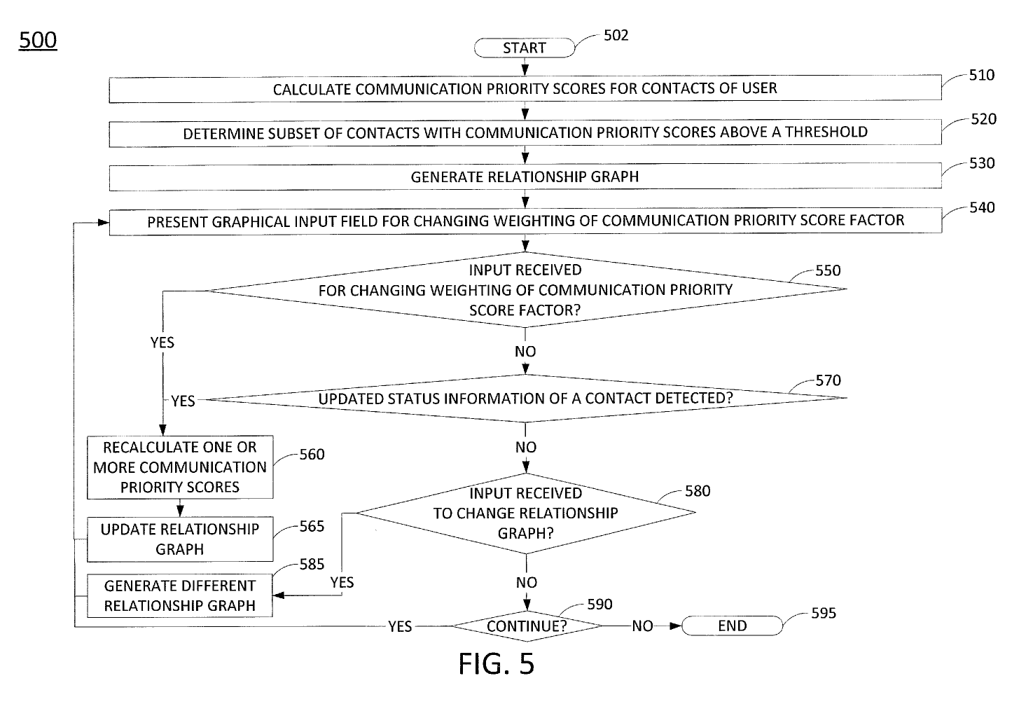

FIG. 5 illustrates a flowchart of a method 500 for presenting a first relationship graph, according to the present disclosure. In one embodiment, steps, functions and/or operations of the method 500 may be performed by a network-based device, e.g., application server 115, in FIG. 1. In another embodiment, steps, functions and/or operations of the method 500 may be performed by a user endpoint device, e.g., endpoint device 170A or 170B in FIG. 1, or by a network-based device in conjunction with a user endpoint device. In one embodiment, the steps, functions, or operations of method 500 may be performed by a computing device or system 600, and/or processor 602 as described in connection with FIG. 6 below. For illustrative purpose, the method 500 is described in greater detail below in connection with an embodiment performed by a processor, such as processor 602. The method begins in step 502 and proceeds to step 510.

At step 510, the processor calculates communication priority scores for one or more contacts of a user. For example, the processor may obtain relationship information from contact lists/address books of the user, as well as from contact lists/address books of contacts of the user, social network connection information, call detail records, and so forth, in order to determine the various contacts of the user. The contacts may comprise both individuals as well as other entities, such as businesses, civic organizations, governmental entities, and so on.

In one example, the processor automatically add different contacts to one or more different social groups, or clusters, based upon communications between the user and the contacts, and between the contacts themselves. In one example, the processor that is clustering the contacts into different social groups may not be aware of the significance of each group. Thus, at a later time the user may be provided the opportunity to label the different social groups that are created via a graphical interface that is presented to the user.

In order to calculate a communication priority score for each contact at step 510, the processor may also obtain context information for the user and for the various contacts, e.g., gleaned from social network activity information, call detail records, calendar entries, location data, and so forth. With such information, the processor may then determine values for various communication priority score factors and calculate the communication priority scores accordingly. For example, for each contact the communication priority score may be based upon relationship strengths, activity ratings, communication histories, locations/distances, and additional factors. In one example, the processor may calculate the communication priority scores according to Equation 1 as disclosed above.

In step 520, the processor determines a subset of contacts having the highest communication priority scores. In one example, the processor may utilize a default threshold number of contacts to be displayed. In another example, a threshold number of contacts may be selected by a user. For instance, a graphical input field such as a slide bar, input dial, drop-down menu or the like may be presented to the user via the graphical interface to enable the user to adjust the threshold. The processor may then select the threshold number of contacts with the highest communication priority scores at step 520. As an alternative, a default or user-selectable threshold may comprise a threshold communication priority score rather than a threshold number of contacts. For instance, the user may desire to have all contacts with a score greater than ‘X’ to be presented, without regard to how many contacts may exceed the threshold.

At step 530, the processor generates a first relationship graph. Exemplary relationship graphs are shown in FIGS. 3 and 4, and discussed above. In one example, the first relationship graph is presented within the graphical interface on the device of the user. As mentioned above, the contacts may be clustered into different social groups. A contact may also belong to more than one social group. Thus, in one example, the first relationship graph may be created in the form of relationship graph 305 or 405 of FIG. 3 and FIG. 4, respectively. Each social group may be represented by a shape that overlaps or is superimposed over an icon for the user in the center. Icons for various contacts are then placed within, overlapping or superimposed on any shapes corresponding to the social groups to which the contacts have been assigned. Shapes for two or more different social groups may also be overlapped where at least one contact is a member of the two or more different social groups. Notably, at step 520, the first relationship graph that is generated includes icons for only those contacts that fall within the threshold number of contacts implemented at step 520.

In one example, the graphical interface presented by the processor may also enable the user to drag and drop different icons for different contacts onto the different shapes corresponding to each social group. Thus, the user may be enabled to manually assign each contact to one or more different social groups, or may have the option to override any automatic assignments of contacts to social groups.

At step 540, the processor presents at least one graphical input field in the graphical interface for changing the weighting of at least one communication priority score factor. For instance, one or more slide bars, dials, drop-down menus, and the like may be presented to enable the changing of weights for factors such as relationship strength, activity rating, communication history, location/distance, and additional factors.

At step 550, the processor determines whether an input is received for changing the weighting of at least one communication priority score factor. For instance, the device of the user may comprise a touch screen device that enables the user to interact with the at least one graphical input field via touch gestures. The device of the user may also comprise a laptop or desktop computer with a mouse such that the user can click and drag, in the case of a slide bar, or otherwise interact with the at least one graphical input field.

If at step 550, an input for changing the weighting of at least one of the communication priority score factors is received, the method 500 proceeds to step 560. Otherwise, the method 500 proceeds to step 570.

At step 560, the processor recalculates communication priority scores for one or more of the contacts in accordance with the weighting change(s) indicated by the input(s) received at step 550.

At step 565, the processor then updates the relationship graph based upon the recalculated communication priority scores. Notably, contacts may move into and out of the top threshold number of contacts as the communication priority scores are recalculated. Thus, the relationship graph depicting only the threshold number of top scoring contacts may change the icons of the contacts that are displayed. Following step 565, the method 500 returns to step 540.

At step 570, the processor determines whether updated context/status information relating to at least one contact is detected. For example, a new communication between the user and one of the contacts may be detected. A change in a location of a contact, a change in location of the user, or simply a change in the distance between the user and the contact may be detected. A new activity of the contact may be detected, e.g., phone/voice or text communications with others, social network activity such as posts, likes, etc., calendar activity, such as reserving a time for an upcoming event, and so on. Updated status information may further comprise a change in time to an upcoming calendared event, such as a sporting event, a social commitment, a recurring milestone for the contact, etc. In this regard, updated status information may be gleaned from any of the same types of records used to determine initial communication priority scores for the various contacts, e.g., call detail records of one or more communication networks, social network activity records, calendar entries to which the user and/or the contacts have granted access, and so forth. If updated status information is not detected at step 570, the method 500 proceeds to step 580.

However, when it is determined that updated status information is received at step 570, the method 500 proceeds to step 560 where the communication priority score for the at least one contact is recalculated in accordance with the current weightings in effect. It should be noted that certain types of context information may impact more than one contact. For example, if the location of the user changes, the distances between the user and multiple contacts will change. Thus, in some instances, step 560 may involve the recalculating of several communication priority scores for all of the contacts that are impacted by the updated status information. Following step 560, the method 500 continues to step 565 to update the relationship graph in accordance with the recalculated communication priority score(s). The method 500 then returns back to step 540.

At step 580, the processor determines whether an input is received to change the relationship graph to another view, or skin. For example, the graphical interface presented to the user may include a button, drop down menu, or similar graphical input field for switching to an alternative view. In the case of a touch-screen based device, the present disclosure may enable a particular gesture to trigger the change in views. Similarly, in the case of a personal computer-based implementation, a particular keyboard key, or combination of keys may be assigned to a command to change views. In any case, if an input to change the view is received at step 580, the method 500 proceeds to step 585. Otherwise, the method 500 proceeds to step 590.

At step 585, the processor regenerates the graphical interface with the different relationship graph. For instance, the relationship graph may change from a Venn diagram view to a 2D graph view as illustrated in relationship graphs 405 and 408, respectively in FIG. 4. The graphical interface with the different relationship graph is then presented via the user's device. Following step 585, the method 500 returns to step 540.

At step 590, the processor determines whether to continue. For example, the method 500 may continue as long as the user chooses to keep the graphical interface running or until power to the user's device is turned off or lost. If it is determined to continue, the method 500 returns to step 540. Otherwise the method 500 proceeds to step 595 where the method ends.

It should be noted that although not specifically specified, one or more steps, functions or operations of the method 500 may include a storing, displaying and/or outputting step as required for a particular application. In other words, any data, records, fields, and/or intermediate results discussed in the respective methods can be stored, displayed and/or outputted to another device as required for a particular application. Furthermore, steps or blocks in FIG. 5 that recite a determining operation or involve a decision do not necessarily require that both branches of the determining operation be practiced. In other words, one of the branches of the determining operation can be deemed as an optional step. In addition, one or more steps, blocks, functions or operations of the above described method 500 may comprise optional steps, or can be combined, separated, and/or performed in a different order from that described above, without departing from the example embodiments of the present disclosure.

As such, the present disclosure provides at least one advancement in the technical field of relationship management interfaces. This advancement is in addition to the traditional contact lists and address books. In particular, the present disclosure provides a context-based communication management service having a graphical interface that effectively depicts the complex and dynamic nature of communication relationships for efficient contact management, e.g., where social relationships between a user and his or her contacts are modeled with a dynamically generated, graphical representation of intersecting social circles. This makes it easy for the user to perceive the nature of the potentially complex social relationships that the user has with his or her contacts in ways that are not possible with existing relationship management methods.

The present disclosure also provides a transformation of data. For example, device location tracking data, call detail record data, social network usage data, calendar activity data, and so forth are transformed into weighted factors and communication priority scores for different contacts of a user, which in turn are transformed into novel relationship graphs as described above. In addition, user inputs are transformed into changes in the weighting of the various factors, which are further transformed into changes in the priority scores and changes to the relationship graphs, as also described above.

Finally, embodiments of the present disclosure improve the functioning of a computing device, e.g., a server and/or a user endpoint device. Namely, a server or endpoint device dedicated for providing relationship management services is improved by providing a novel graphical interface for context-based communication management, and more specifically by providing relationship graphs in accordance with user-selectable weightings of various factors that are used to calculate communication priority scores for different contacts.

FIG. 6 depicts a high-level block diagram of a computing device suitable for use in performing the functions described herein. As depicted in FIG. 6, the system 600 comprises one or more hardware processor elements 602 (e.g., a central processing unit (CPU), a microprocessor, or a multi-core processor), a memory 604 (e.g., random access memory (RAM) and/or read only memory (ROM)), a module 605 for providing a context-based communication management service, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 500 as discussed above is implemented in a distributed or parallel manner for a particular illustrative example, i.e., the steps of the above method 500, or the entire method 500 is implemented across multiple or parallel computing device, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 500. In one embodiment, instructions and data for the present module or process 605 for providing a context-based communication management service (e.g., a software program comprising computer-executable instructions) can be loaded into memory 604 and executed by hardware processor element 602 to implement the steps, functions or operations as discussed above in connection with the illustrative method 500. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 605 for providing a context-based communication management service (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method for presenting a first relationship graph, comprising:
calculating, by a processor, a communication priority score for each of a plurality of contacts of a user, wherein the communication priority score is based upon a communication priority score factor, wherein the communication priority score factor has a weighting;
determining, by the processor, a subset of the plurality of contacts having communication priority scores above a threshold;
generating, by the processor, the first relationship graph including an icon representing the user and a plurality of shapes overlapping the icon representing the user, wherein each of the plurality of shapes is associated with one of a plurality of social groups of the user, wherein each of the plurality of shapes includes a second icon representing a contact of the subset of the plurality of contacts that is a member of a social group of the plurality of social groups that is associated with a shape of the plurality of shapes; and
presenting, by the processor, a graphical input field for changing the weighting of the communication priority score factor.

2. The method of claim 1, further comprising:
receiving, by the processor, an input for changing the weighting of the communication priority score factor;
recalculating, by the processor, the communication priority score for each of the plurality of contacts in accordance with the input;
re-determining, by the processor, the subset of the plurality of contacts; and
regenerating, by the processor, the first relationship graph in accordance with the subset of the plurality of contacts that is recalculated.

3. The method of claim 1, wherein the graphical input field comprises one of:
a slider bar;
an input dial; or
a drop-down menu of weights to be selected for the communication priority score factor.

4. The method of claim 1, wherein the plurality of shapes represents a number of social groups to which the user belongs.

5. The method of claim 1, wherein, for each of the plurality of contacts of the user, the communication priority score factor comprises a relationship strength between the user and each contact.

6. The method of claim 1, wherein, for each of the plurality of contacts of the user, the communication priority score factor comprises an activity rating of each contact, the activity rating comprising a volume of communication activities of each contact within a defined period of time.

7. The method of claim 1, wherein, for each of the plurality of contacts of the user, the communication priority score factor comprises a communication history between the user and each contact, wherein a greater duration of time that has elapsed from a most recent communication between the user and each contact results in a lower communication priority score as compared to a lesser duration of time that has elapsed from the most recent communication between the user and each contact.

8. The method of claim 1, wherein, for each of the plurality of contacts of the user, the communication priority score factor comprises a distance between the user and each contact, wherein a closer distance between the user and each contact results in a higher communication priority score as compared to a further distance between the user and each contact.

9. The method of claim 1, wherein the second icon for a first contact of the plurality of contacts with a higher communication priority score is displayed as larger than the second icon for a second contact of the plurality of contacts with a lower communication priority score in the first relationship graph.

10. The method of claim 1, further comprising:
detecting, by the processor, updated status information regarding a first contact of the plurality of contacts; and
recalculating, by the processor, a communication priority score for the first contact based upon the updated status information.

11. The method of claim 10, wherein the updated status information comprises a new communication between the user and the first contact.

12. The method of claim 10, wherein the updated status information comprises a new activity of the first contact.

13. The method of claim 10, wherein the updated status information comprises a change in a location of the first contact.

14. The method of claim 10, wherein the updated status information comprises a change in a time until an upcoming event associated with the first contact.

15. The method of claim 10, wherein the updated status information is obtained from at least one of: a social network activity record, a call detail record of a communication network, and a calendar entry.

16. The method of claim 1, wherein the communication priority score is calculated in accordance with a formula comprising:
PRᵢ=(RSᵢ×RSW)+(ARᵢ×ARW)+(CHᵢ×CHW)+(Lᵢ×LW),
wherein for an i^{th} contact of the plurality of contacts, PRᵢ is a communication priority score of the i^{th} contact, RSᵢ is a relationship strength between the user and the i^{th} contact, RSW is a weighting for the relationship strength, ARᵢ is an activity rating of the i^{th} contact, ARW is a weighting for the activity rating, CHᵢ is a communication history for communications between the user and the i^{th} contact, CHW is a weighting for the communication history factor, Lᵢ is a distance between the user and the i^{th} contact, and LW is a weighting for the distance.

17. The method of claim 1, further comprising:
receiving, by the processor, an input to change a second relationship graph;
generating, by the processor, the second relationship graph, the second relationship graph comprising a third icon representing the user and a plurality of fourth icons representing the plurality of contacts connected to the third icon representing the user via a plurality of lines, wherein a length of each line of the plurality of lines is based upon a communication priority score of a respective contact having a fourth icon that is associated with the line and a thickness of each line plurality of lines is based upon a relationship strength between the user and the contact having the fourth icon that is associated with the line; and
presenting, by the processor, the second relationship graph via a device of the user.

18. The method of claim 1, wherein at least two of the plurality of shapes overlap, wherein the second icon representing one of the contacts of the subset of the plurality of contacts is displayed in an area of overlap between the at least two of the plurality of shapes when the one of the subset of the plurality of contacts is a member of a first social group and a second social group of the plurality of social groups that are associated with the at least two of the plurality of shapes.

19. A tangible computer-readable medium storing instructions which, when executed by a processor, cause the processor to perform operations for presenting a first relationship graph, the operations comprising:
calculating a communication priority score for each of a plurality of contacts of a user, wherein the communication priority score is based upon a communication priority score factor, wherein the communication priority score factor has a weighting;
determining a subset of the plurality of contacts having communication priority scores above a threshold;
generating the first relationship graph including an icon representing the user and a plurality of shapes overlapping the icon representing the user, wherein each of the plurality of shapes is associated with one of a plurality of social groups of the user, wherein each of the plurality of shapes includes a second icon representing a contact of the subset of the plurality of contacts that is a member of a social group of the plurality of social groups that is associated with a shape of the plurality of shapes; and
presenting a graphical input field for changing the weighting of the communication priority score factor.

20. A device, comprising:
a processor; and
a computer-readable medium storing instructions which, when executed by the processor, cause the processor to perform operations, the operations comprising:
calculating a communication priority score for each of a plurality of contacts of a user, wherein the communication priority score is based upon a communication priority score factor, wherein the communication priority score factor has a weighting;
determining a subset of the plurality of contacts having communication priority scores above a threshold;
generating the first relationship graph including an icon representing the user and a plurality of shapes overlapping the icon representing the user, wherein each of the plurality of shapes is associated with one of a plurality of social groups of the user, wherein each of the plurality of shapes includes a second icon representing a contact of the subset of the plurality of contacts that is a member of a social group of the plurality of social groups that is associated with a shape of the plurality of shapes; and
presenting a graphical input field for changing the weighting of the communication priority score factor.
